(19) United States
(12) Patent Application Publication
(10) Pub. No.: US 2026/0234941 A1
(43) Pub. Date: Aug. 13, 2026

(54) STRIP-SHAPED PLATE

(71) Applicant: Maria Leitl, Furniere und Laubschnittholz OG, Wördern (AT)

(72) Inventor: Mieczyslaw Kazimierz BYRTEK, Zarzecze (PL)

(21) Appl. No.: 18/578,852

(22) PCT Filed: Jan. 20, 2023
(86) PCT No.: PCT/EP2023/051370

§ 371 Date: Jul. 25, 2025

(30) Foreign Application Priority Data
Jan. 21, 2022 (EP) 22152756.7

(51) Int. Cl. E04F 13/08; B32B 7/12; B32B 21/02; B32B 21/08; B32B 37/12

(52) U.S. Cl. CPC E04F 13/0887; B32B 7/12; B32B 21/02; B32B 21/08; B32B 37/1284; B32B 2307/7375; B32B 2451/00

(57) ABSTRACT

The application relates to a strip-shaped plate for panelling a wall or ceiling surface, wherein an adhesive surface is provided on a rear side of the plate, wherein the adhesive surface is formed by a double-sided adhesive tape and is covered by a protective film, to a system including at least one such plate and a spacer, wherein the spacer is designed to be fitted onto the at least one plate, and to a method for panelling a wall or ceiling surface by attaching several strip-shaped plates.

The invention relates to a slat-shaped lamella for panelling a wall or ceiling surface and to a corresponding method.

The surface panelling by means of slat-shaped lamellas, which are usually of the same width and are arranged at regular intervals, is becoming increasingly popular in order to influence the visual appearance of surfaces. Such panelling can emphasise, for example, the appearance of length in the case of horizontal lamellas or the appearance of the height of a surface in the case of vertical lamellas. Particularly popular are lamellas with a wood look, e.g. with real wood surfaces or wood-like plastic decoration.

Known lamellas of this type must be combined with suitable fastening means during assembly. For example, they must be attached to a substrate with nails or screws or provided with an assembly adhesive applied to the substrate or to the lamellas and then adhered on.

Another type of surface panelling, namely a full-surface cladding with panels, is shown in DE 2 113 755A1. In this case, tongue and groove joined panels are attached directly to a wall by means of self-adhesive foam strips.

Comparable panels for cladding a wall are also disclosed in WO 2017/017139 A1. There, adhesive strips are used to temporarily fix the panels before an assembly adhesive applied between the adhesive strips on the rear side of the panels hardens and achieves permanent fixation.

Very similar panel products are also shown in CN 104278811 A and CN 104234359 A.

Not applying to products for a surface panelling, but to slats of a substructure, GB 1 379 932 A shows an adhesive tape as a fixing aid until an additionally necessary adhesive is cured in order to permanently fix the panels carried by the slats.

It is an object of the invention to simplify the assembly of slat-shaped lamellas for panelling a wall or ceiling surface.

The invention proposes a lamella of the type mentioned at the outset, wherein an adhesive surface is provided on a rear side of the lamella, wherein the adhesive surface is formed by a double-sided adhesive tape and is covered with a protective film. The protective film protects the adhesive surface when the lamella is delivered. In other words, the lamella has a pre-fitted double-sided adhesive tape. As a result, the step of applying an assembly adhesive to the lamella during assembly can be omitted.

In this context, “lamella” or also slats or strips are understood to be relatively narrow elements whose ratio of height (thickness) to width (of a surrounding cuboid) is in a range of 0.05-3.0. In this context, “slat-shaped” is understood to be those lamellas, slats or strips whose ratio of width to length (of a surrounding cuboid) is in a range of 0.5% to 10.0%. The lamella preferably has flat, optionally oblique, side surfaces. The width of the lamella may be between 20 and 110 mm, for example, in particular between 20 and 80 mm. Its thickness may be between 2.5 mm and 60 mm, for example, and its length may be between 1000 mm and 3000 mm, for example.

Correspondingly, the invention proposes a method for panelling a wall or ceiling surface by attaching several slat-shaped lamellas, the method comprising at least one repetition of the following steps:
peeling off a protective film from an adhesive strip pre-fitted onto a slat-shaped lamella;
adhering the lamella to a substrate at a distance from a lamella already attached to the substrate.

For the method, the order of the steps between the individual repetitions is irrelevant and the invention is not limited to a specific order between the repetitions. In particular, the peeling and adhering steps do not necessarily have to alternate between the repetitions.

Optionally, the double-sided adhesive tape is suitable for permanently fixing the lamella. This eliminates the need for additional fastening means and further simplifies assembly.

The lamella may comprise, for example, a body of wood-based material having a decorative layer, wherein the decorative layer extends at least over a front side of the lamella, wherein the front side is a side of the lamella facing away from the rear side with the adhesive layer. This embodiment achieves greater dimensional stability and less susceptibility to deformation than solid wood lamellas.

### Optionally, the Decorative Layer Can Additionally Extend

over at least one longitudinal side surface of the lamella. The longitudinal side surfaces adjoin the front side and the rear side of the lamella via longitudinal side edges and they adjoin the two smaller front sides of the lamella via front side edges.

According to an embodiment of this disclosure, the decorative layer may comprise a real wood veneer. As a result, the advantages of the dimensional stability of a body made of wood-based material can be combined with the advantageous appearance of real wood. Alternatively, the decorative layer may comprise a printed plastic film, for example. This allows for cheaper production as well as virtually any graphical (two-dimensional) surface panelling.

The wood-based material may be, for example, a wood fibre-based material, in particular a medium-density wood fibre material (“MDF”), high-density wood fibre material (“HDF”), a wood chip-based material, or plywood.

According to a further embodiment, the disclosure relates to a system comprising at least one lamella according to one of the above-described variants and a spacer, wherein the spacer is designed to be fitted onto the at least one lamella. The system may comprise, in particular, several lamellas having the same width, in particular several lamellas having the same dimensions in width, height and length.

Accordingly, the disclosed method may further comprise, for example, the following steps prior to adhering the lamella: fitting at least one spacer onto the lamella to be adhered; and aligning the lamella to be adhered by positioning the fitted spacer against the lamella already attached to the substrate.

In the same context, the disclosed method according to another example may further comprise the following steps prior to adhering the lamella: fitting at least one spacer onto the lamella already attached to the substrate; and aligning the lamella to be adhered by positioning it against the fitted spacer.

The spacer of the system or the use of a spacer within the scope of the disclosed method represents a further simplification of the assembly, because a regular and parallel arrangement of the lamellas can be achieved in an easy-to-handle and reliable manner, which is advantageous for the desired visual appearance.

Optionally, in the method described above, the distance at which the lamella is adhered to the substrate may correspond to at least 0.1 times and at most 1.5 times the width of the lamella already attached to the substrate. It has been found that the desired visual appearance can be achieved effectively in this range.

Accordingly, in the system described above, the distance indicated by the spacer may optionally correspond to at least 0.1 times and at most 1.5 times the width of the at least one lamella.

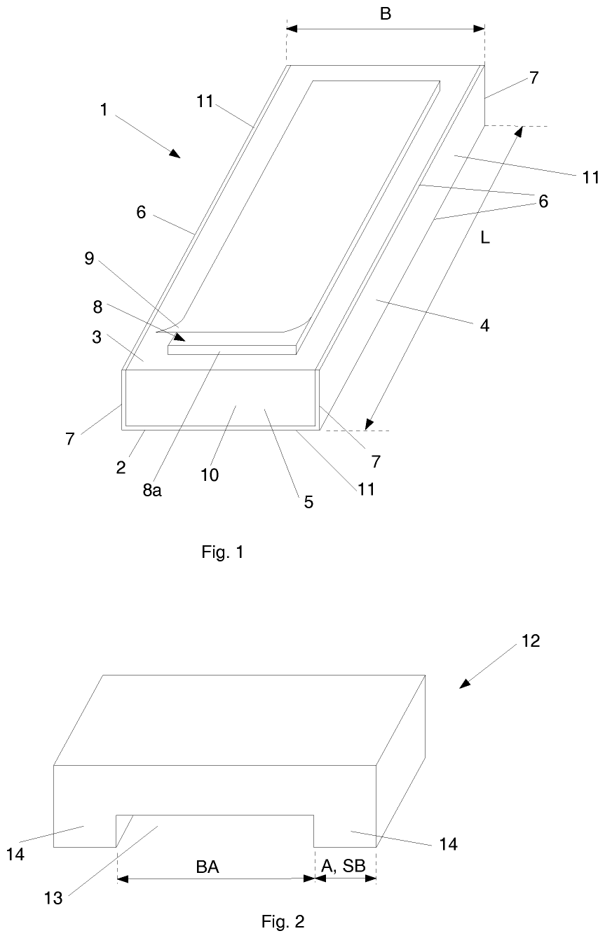

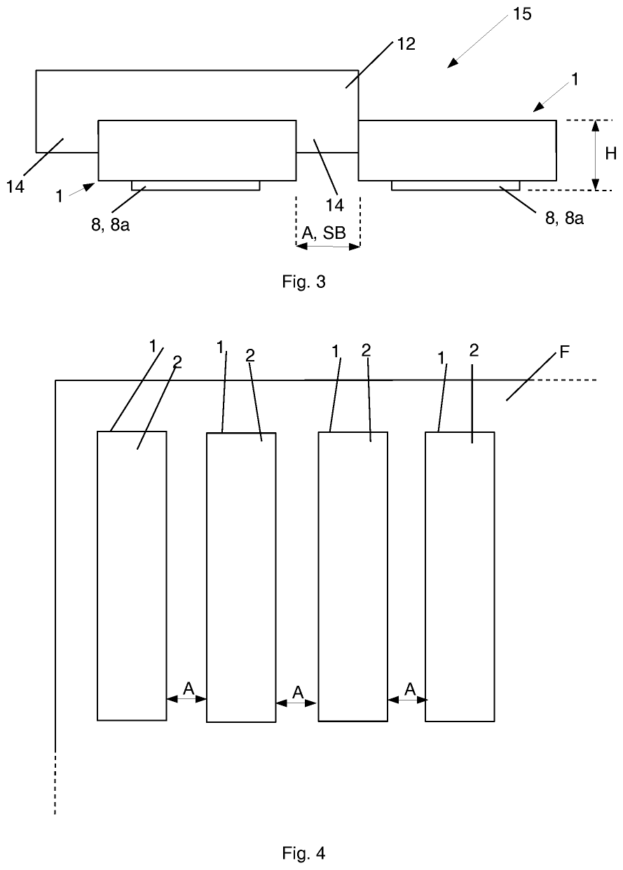

The invention will be explained in more detail below with reference to particularly preferred exemplary embodiments, to which, however, it shall not be limited, and with reference to the drawings. The drawings show in detail:
FIG. 1 schematically, a perspective view of a slat-shaped lamella according to the invention, with a double-sided adhesive tape having a protective film;
FIG. 2 schematically, a spacer in a perspective view, which is designed to be fitted onto the lamella of FIG. 1;
FIG. 3 schematically, the spacer of FIG. 2 in a sectional view in a state in which it is fitted onto the lamella of FIG. 1 and a further lamella positioned against it; and
FIG. 4 schematically, a wall or ceiling surface with several lamellas according to FIG. 1 adhered onto it.

FIG. 1 shows a slat-shaped lamella 1 for panelling a wall or ceiling surface F. The lamella 1 has a front side 2, a rear side 3 opposite it or facing away from it, two longitudinal side surfaces 4, of which only one is visible in FIG. 1, and two smaller-area front sides 5, of which only one is also visible in FIG. 1. The longitudinal side surfaces 4 adjoin the front side 2 and the rear side 3 of the lamella 1 via longitudinal side edges 6 and they adjoin the two smaller front sides 5 of the lamella 1 via front side edges 7. The lamella 1 has a length L, a width B and a height or thickness H. It can clearly be seen in FIG. 1 that an adhesive surface 8 is provided on the rear side 3 of the lamella 1, the adhesive surface 8 being formed by a double-sided adhesive tape 8a and being covered with a protective film 9. In particular, the protective film 9 is designed to be peelable and is made, for example, of paper and/or plastic. In FIG. 1, the protective film 9 is already partially detached from the double-sided adhesive tape 8a at a front end. In the delivery state of the lamella 1 (not shown), the protective film 9 preferably completely covers the adhesive surface 8 or the double-sided adhesive tape 8a in order to protect the latter.

The double-sided adhesive tape 8a is preferably designed to permanently fix the lamella 1. A person skilled in the art can expediently select a suitable double-sided adhesive tape 8a depending at least on the substrate on which the lamella 1 is to be adhered and on the expected load on the lamella 1 and thus on the double-sided adhesive tape 8a in the adhered state of the lamella 1. Preferably, the double-sided adhesive tape 8a extends over at least 90% of the length L of the lamella 1. In addition, the adhesive tape 8a is preferably designed to be continuous, in order to ensure the most secure and complete hold possible even in the event of a shortening of the lamella (e.g. by sawing off).

The lamella 1 shown in FIG. 1 has a body 10 made of wood-based material (e.g. MDF) with a decorative layer 11, wherein the decorative layer 11 extends at least over the front side 2 of the lamella 1. In the example shown in FIG. 1, the decorative layer 11 additionally extends over both longitudinal side surfaces 4 of the lamella 1. According to another exemplary embodiment (not shown), the longitudinal side surfaces 4 are formed without a decorative layer 11, i.e. in this case they are formed by the side surfaces of the body 10. In contrast to solid wood, the body 10 preferably comprises a binder or adhesive material. Particularly preferably, the wood-based material is a wood fibre-based material, in particular a medium-density wood fibre material, high-density wood fibre material (“HDF”), a wood chip-based material or plywood.

FIG. 2 shows a spacer 12, which is designed to be fitted onto the at least one lamella 1. For this purpose, the spacer 12 has a recess 13, into which a part of the lamella 1 can be received. On both sides of the recess 13, the spacer 12 according to FIG. 2, which is roughly U-shaped or inverted U-shaped, has a leg 14 with a leg width SB, which, in a state in which the spacer 12 is positioned against a lamella 1, predetermines a distance A to an adjacent lamella 1 to the extent of the leg width SB. Expediently, the width BA of the recess 13 corresponds substantially to the width B of the lamella 1 in order to achieve a frictional connection when fitted on. The distance A indicated by the spacer 12, i.e. in the example according to FIG. 2 the leg width SB, corresponds to at least 0.1 times and at most 1.5 times the width B of the at least one lamella 1.

FIG. 3 shows a cross-sectional view of the spacer 12 in a state in which it is fitted onto a lamella 1, as well as a second lamella 1, which is positioned against the spacer 12 at a distance A equal to the leg width SB. The spacer 12 and the at least one lamella 1 form a system 15.

FIG. 4 shows, schematically and not to scale, a section of a wall or ceiling surface F with several lamellas 1 adhered thereto, of which the front side 2 is visible. In the example according to FIG. 4, the lamellas 1 are arranged parallel to one another, with adjacent lamellas 1 having a distance A between them. In a different embodiment (not shown), the lamellas 1 can, of course, have an orientation that deviates from a vertical orientation, for example, a horizontal longitudinal profile. For simple parallel assembly f the lamellas 1, the system 15 preferably has two spacers 12 in addition to the at least one lamella 1.

1. A slat-shaped lamella for panelling a wall or ceiling surface wherein an adhesive surface is provided on a rear side of the lamella, wherein the adhesive surface is formed by a double-sided adhesive tape and is covered with a protective film.

2. The lamella according to claim 1, wherein the double-sided adhesive tape is suitable for permanently fixing the lamella.

3. The lamella according to claim 1, wherein the lamella comprises a body of wood-based material having a decorative layer, wherein the decorative layer extends at least over a front side of the lamella, wherein the front side is a side of the lamella facing away from the rear side with the adhesive layer.

4. The lamella according to claim 3, wherein the decorative layer additionally extends over at least one longitudinal side surface of the lamella.

5. The lamella according to claim 3, wherein the decorative layer comprises a real wood veneer.

6. The lamella according to claim 3, wherein the decorative layer comprises a printed plastic film.

7. The lamella according to claim 3, wherein the wood-based material is a wood fibre-based material, comprising at least one of a medium-density wood fibre material, high-density wood fibre material (“HDF”), a wood chip-based material or plywood.

8. A system comprising at least one lamella according to claim 1 and a spacer, wherein the spacer is designed to be fitted onto the at least one lamella.

9. The system according to claim 8, wherein the distance indicated by the spacer corresponds to at least 0.1 times and at most 1.5 times the width (B) of the at least one lamella.

10. Method for panelling a wall or ceiling surface (F) by attaching several slat-shaped lamellas, the method comprising at least one repetition of the following steps:
peeling off a protective film from an adhesive strip pre-fitted onto a slat-shaped lamella;
adhering the lamella to a substrate at a distance (A) from a lamella already attached to the substrate.

11. The method according to claim 10, wherein the distance (A) corresponds to at least 0.1 times and at most 1.5 times the width (B) of the lamella already attached to the substrate.

12. The method according to claim 10, further comprising the following steps before adhering the lamella:
fitting at least one spacer onto the lamella to be adhered; and
aligning the lamella to be adhered by positioning the fitted spacer against the lamella already attached to the substrate.

13. The method according to claim 10, further comprising the following steps before adhering the lamella:
fitting at least one spacer onto the lamella already attached to the substrate; and
aligning the lamella to be adhered by positioning it against the fitted spacer.
